(19) United States
(12) Patent Application Publication
(10) Pub. No.: US 2002/0123971 A1
(43) Pub. Date: Sep. 5, 2002

(54) Method and system of conducting network-based transactions

(76) Inventors: L. Michael Maritzen, Fremont, CA (US); Harold Aaron Ludtke, San Jose, CA (US)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 10/015,070

(22) Filed: Dec. 11, 2001

Related U.S. Application Data
(60) Provisional application No. 60/254,562, filed on Dec. 11, 2000.

(51) Int. Cl. G06F 17/60

(52) U.S. Cl. 705/64; 705/39; 705/26

(57) ABSTRACT

A system and method for performing financial transaction clearing, settlement, and fraud prevention in real time over a network. The invention uses intelligent agents and component based objects in an interactive network to allow secure financial transactions to be conducted.

This application claims the benefit of U.S. Provisional Patent Application No. 60/254,562, entitled PLATFORM-INDEPENDENT REAL-TIME AGENT-DRIVEN COMPONENT-BASED SETTLEMENT AND FRAUD PREVENTION OF FINANCIAL TRANSACTION PROCESSING, filed Dec. 11, 2000, the entire disclosure of which is hereby incorporated by reference in its entirety.

### BACKGROUND OF THE INVENTION

Most credit card institutions today use a financial transaction system that is commonly referred to as legacy settlement. The financial system that Visa® International uses is a current example.

Legacy settlement is performed in batch. All settlement calculations and related processing activity for a given day occurs at a predetermined time. If a merchant or bank fails to submit their daily transactions by the predetermined time, their transactions will be processed the following business day. The financial impact for the merchant or bank may be significant. This issue results in a close dependence between a merchant's account processing and the manual involvement necessary to ensure that transactions get posted and settled as soon as possible. Since processing occurs sometime after the actual purchase, fraud is a significant and costly occurrence in traditional legacy implementations.

Most legacy systems are based on a financial or bank-centric processing model. These models tend not to include the consumer in the transaction path. Consumers are also often excluded from credit discounts or fee waivers because they are based on volumes and agreements between the merchant, bank and processing center or association. Consumers may also be excluded from agreements between the merchants, banks and processing centers that optimize discounts based on consumer preferences, demographics and prior transactional history.

Another disadvantage of typical legacy systems is that the systems used to process transactions are often incapable of effectively conveying information to one another. For example, web sites normally require customers to place their credit card information on online forms. Many of these web sites, however, have no computerized method for automatically transferring this data to the credit card processing network. As such, the information must be manually entered by a person sitting at a computer, reading the data from the screen, then keying the data into a second computer or piece of equipment just as if the information were provided by phone.

Although gradual advances have been made to rectify these problems, the software solutions are inclined to be “ad hoc”. For example, many have no end-to-end security like those found in PKI-based solutions, such as encryption, digital signatures and the like. Many have no meta-data support, such as the tracking of purchase demographics that are subsequently used to augment the transaction (such as dynamically selecting an advantageous discount for unusually loyal customers).

Moreover, in many legacy credit card processing systems, the system infrastructure (both hardware and software) was designed using out-of-date techniques. The result is that the system is in fact quite fragile from a software/system maintenance standpoint. To change even a small set of data structures that will allow the tracking of a new piece of information, which is then intended to be realized as a new type of service or feature that the user would see, can be quite difficult to implement. Such changes also require developing processes at the consumer level to ensure complete backward compatibility with the legacy system. Similar to the limitations imposed on legacy systems, backward compatibility prevents banks and retailers from taking advantage of the newer technologies and methodologies such as the migration of some services and products to the World Wide Web.

Another disadvantage of legacy systems is that the merchant must usually purchase and maintain equipment that is proprietary to the credit card company. This can lead to limited options for equipment and software, thus driving down choice and driving up prices or costs.

Accordingly, there is a need for a financial settlement system that is not limited to proprietary and costly hardware and software implementation, but provides support for standard hardware and software protocols maximizing customization while minimizing the potential for fraudulent activities.

### SUMMARY OF THE INVENTION

The present invention provides systems and methods for performing financial transaction clearing, settlement, and fraud prevention in real time. The invention uses intelligent agents and component based objects in an interactive network to allow secure financial transactions to be conducted. The invention allows for rapid legacy system revisions such as added security, debugging, change requests, new product/service release, and others. The invention communicates over a network that comprises a plurality of servers, a distribution network and user access/communication devices.

The methods obviate chargeback and fraud by placing preventative measures at consumer access points or at consumer points-of-sale. The methods employ complete transaction life-cycle processing that eliminate and/or provide fully automated transaction flows and related processing activities and eliminate the need for manual intervention and/or software filters.

In accordance with the invention, a method of conducting a transaction over a network of nodes is provided. The nodes include a user node associated with a user, a merchant node associated with a merchant of goods or services, a bank node associated with account information pertaining to the user, and a clearinghouse node. The method comprises, at the clearinghouse node, receiving a request from the user node for the purchase of at least one of the goods or services of the merchant and determining whether the user is authorized to purchase the goods or services by exchanging information with the bank node such that the bank node updates the user account information in the event of authorization. The method further comprises, if the purchase is authorized, sending notification of the authorization to the user node and merchant node such that the good or service is not provided until such notification is received by the merchant.

The method further preferably comprises recording purchases and reducing the cost of the good or service in the event the user has previously purchased goods or services from other merchants.

### BRIEF DESCRIPTION OF THE DRAWINGS

FIG. 1 is a system for conducting secure financial transactions and settlement over a network in accordance with the present invention.

FIGS. 2A and 2B are a flow diagram of a method of financial settlement in accordance with the present invention.

### DETAILED DESCRIPTION OF THE PREFERRED EMBODIMENTS

The preferred embodiment will be described with reference to the drawing figures where like numerals represent like elements throughout.

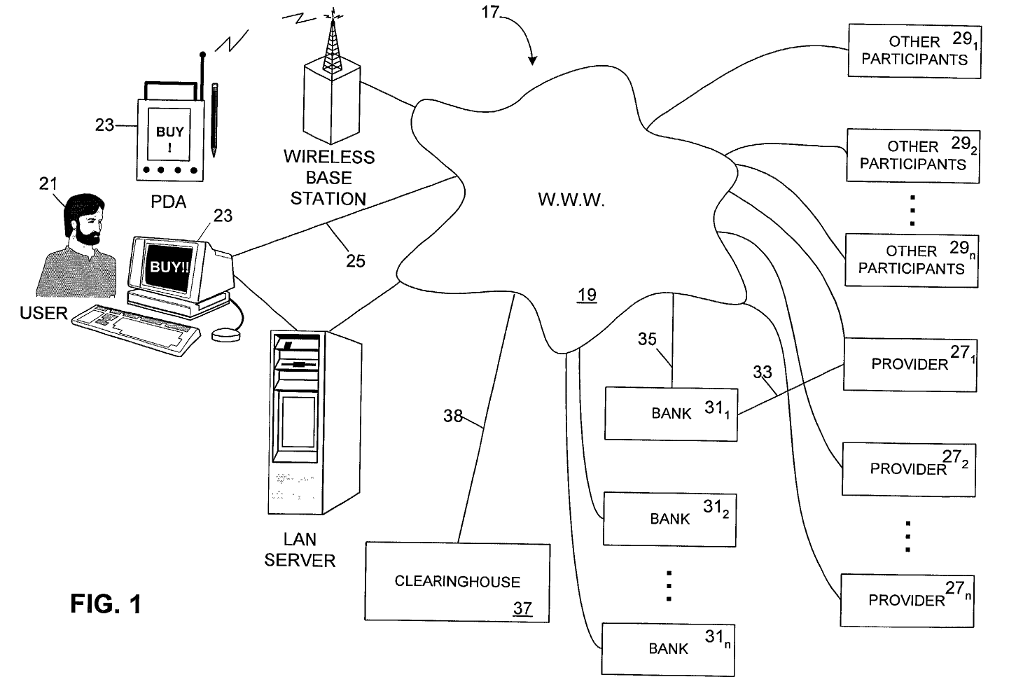

FIG. 1 illustrates a system 17 for conducting financial transactions over the World Wide Web (web) 19 or over other computer networks in accordance with the present invention. As shown in FIG. 1, a consumer 21 uses one of a variety of access/communication devices 23 coupled to the web 19. There may be many consumers 21 carrying on contemporaneous transactions. The communication device 23 couples to the web 19 using a variety of links 25 that include telephone lines, cable systems, optical systems, wireless systems, satellite systems, or any other system capable of transmitting information between a communication device 23 and a computer network. The communication device 23 may be any device for transmitting and receiving such information.

The communication device 23 typically comprises a central processing unit (CPU) and a network connection device such as a network adapter card, a network interface card, a standard cable modem, a DSL modem, an ADSL modem, an ISDN modem, a cable modem or a wireless modem.

The communication device 23 may be a personal digital assistant (PDA), cell phone, satellite broadcasting set top box, a portable computer, a personal computer, server, digital wallet, electronic wallet, point-of-sale (POS) terminal, ATM machine, cable set top box, landline telephone or any other communication-enabled device. The communication device may use either a wired or a wireless interface to communicate with the web 19. In lieu of the web 19, any network capable of providing communications between and among such devices may be employed.

Using the communication device 23, the consumer 21 may access a plurality of providers 27₁, 27₂, . . . 27ₙ. The providers 27₁, 27₂, . . . 27ₙ may be any entities providing goods or services over the web 19. The services may include consumer goods, electronic banking, movie tickets, stock trading, news, information or any other goods or services. Other participants 29₁, 29₂, . . . 29ₙ such as individuals, credit institutions such as Visa®, MasterCard®, and the like, and other entities, also interact with the providers 27₁, 27₂, . . . 27 ₙ consumer 21 and other consumers over the web 19.

Banks 31₁, 31₂, . . . 31ₙ communicate with the providers 27₁, 27₂, . . . 27ₙ and other participants 29₁, 29₂, . . . 29ₙ ver dedicated communication links 33 or links 35 to the web 19. The banks 31₁, 31₂, . . . 31ₙ provide financial information, such as the verification of consumer credit information to the providers 27₁, 27₂, . . . 27ₙ to assist the providers in conducting sales transactions.

Interacting over link 38 and web 19 among the pluralities of providers 27₁, 27₂, . . . 27ₙ, participants 29₁, 29₂, . . . 29ₙ, banks 31₁, 31₂, . . . 31ₙ, and consumer(s) 21 is a clearinghouse 37. The clearinghouse 37 provides account settlement for all transactions and related services for its associates which, for the purposes of illustration, shall be deemed to include providers 27₁, 27₂, . . . 27ₙ, banks 31₁, 31₂, . . . 31ₙ, and consumer(s) 21.

The clearinghouse 37 allows settlement of transactions. Preferably, it is also a centralized intelligent monetary system providing irrevocable and fraudulent-free debit and credit transactions, and net settlement in real time such that the transaction is authorized at the point of purchase and the various associates are informed of the transaction at the time of its occurrence. The clearinghouse 37 provides its transactional associates and consumer(s) 21 personalized services using the consumer relationship as the starting point of a transaction life cycle.

Accordingly, the clearinghouse 37 desirably acts as the central agency for collecting, classifying and distributing credits and debits among transactional participants using a plurality of intelligent agents. On the web 19, agents, sometimes referred to as spiders, robots, or knowbots, use information gathered from an entity and automatically search and perform predetermined, dedicated tasks.

The clearinghouse 37 supports both-web based purchasing activities from a consumer 21 using, for example, a personal computer as the communication device 23 as well as traditional legacy settlement services such as those by other participants Visa® or MasterCard® 29₁, 29₂, . . . 29ₙ. The clearinghouse 37 is a common node among providers 27₁, 27₂, . . . 27 ₙ participants 29₁, 29₂, . . . 29ₙ, banks 31₁, 31₂, . . . 31ₙ, and consumer 21. The clearinghouse 37 is platform independent and can be used regardless of the specific implementation of the communication device 23.

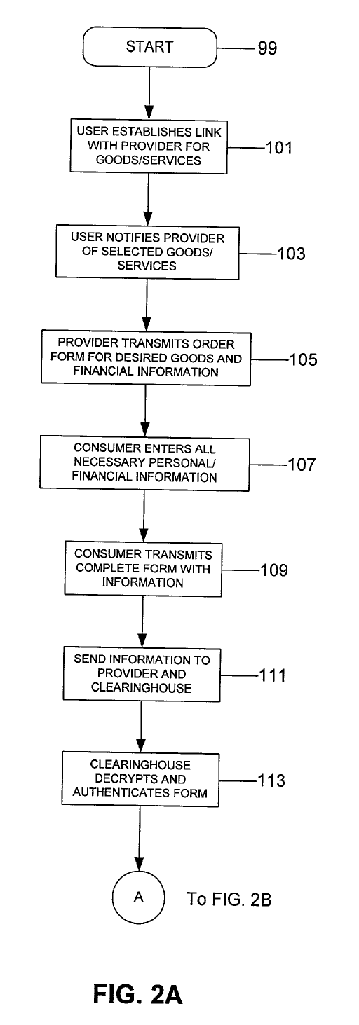

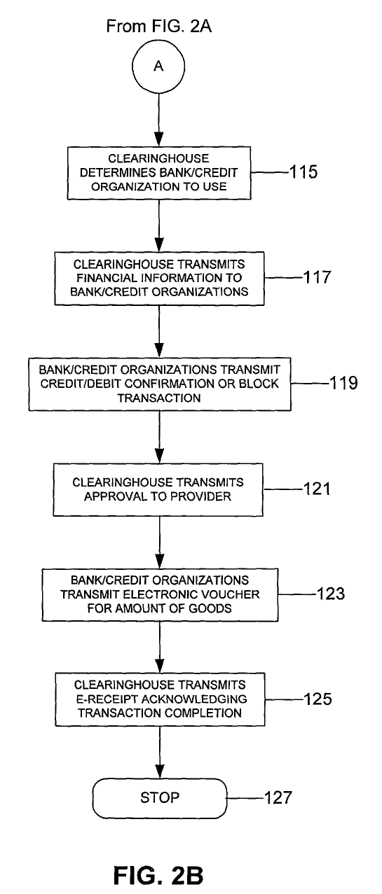

A flow diagram for conducting a transaction with a provider 27₁, 27₂, 27ₙ of goods or services in accordance with the present invention is shown in FIGS. 2a-2b. This example is applicable to any entity conducting transactions with individuals or other entities over any computer network.

Referring to FIGS. 2A-2B, the consumer 21, using conventional methods (step 99) connects to a provider 27₁ over the web 19 using a communication device 23 (step 101). The consumer 23 browses the website of a provider 27₁ and selects goods for purchase. The consumer 23 notifies the provider 27₁ of his selection of goods for purchase. The notification may occur by using a pointing device to “mouse over” an icon, object, or a graphic representing the goods, and subsequently clicking or acknowledging, or sending a message to the provider 27₁ (step 103).

In response, the provider 27₁ transfers to the consumer 23 over the web 19 a form (step 105) having a plurality of fields for completion requesting various personal and financial information (i.e. name, address, quantity of goods, payment information, or the like.).

The consumer 23 enters all of the necessary personal and financial information onto the form (step 107). The consumer 23 then transfers the form fields back to the provider 27₁ (step 109). All of the personal and financial information entered onto the form by the consumer 23 is encrypted and transmitted to the provider 27₁ and clearinghouse 37. Encrypting and decrypting plain text are known to those skilled in this art and is beyond the scope of this disclosure.

The clearinghouse 37 acquires the ordering information from the consumer 23 using an agent sent from the consumer's communication device 23. The agent may have been installed in the communication device 23 in a number of ways. For example, a single “master agent” may be installed on the device at the time it is manufactured and then subsequently activated and informed of the user's information when the device is first initialized by the user. Alternatively, a master agent may be downloaded from the clearinghouse when the device is being initialized and/or the user signs up with a clearinghouse.

Yet further and preferably, any number of agents may be downloaded, at any time, from the various service providers that the user deals with. Typically, this would take place the first time the user signs up with a service provider as a new customer. Part of that service registration process would include downloading and installing a service-specific agent. Once downloaded and personalized with the user's information, that agent becomes both service-specific and user-specific. This way, at the time of a transaction, the service-and-user-specific agent can then be transmitted to the clearing house to assist in the transaction processing. It is desirable for the agent to have a unique set of knowledge about the consumer, such as knowledge that is only available by collecting it at the communication device as the user interacts with the device. This data can be acquired in an incremental manner, for example, the agent can pose an occasional question to the user and store the response in a continuously-growing knowledge database on the mobile device. The questions to ask can be downloaded on occasion by the service provider to the device-resident agent. Thus, when the service provider comes up with a new survey question for its installed base of customers, the agents can be dynamically updated to ask the new question(s).

Once the agent is downloaded to the clearinghouse, it will have a vast storehouse of transaction history data available to it. The data is likely far too large to be permanently stored on the mobile device. In addition, the agent will have access to the sophisticated database management services that would typically be installed in a clearing house that processes millions of transactions on a daily basis.

In any event, the agent is sent from the consumer 21's communication device 23 to the clearinghouse 37 contemporaneous with the ordering information (step 111).

The clearinghouse 37 knows a priori the consumer's banks 31₁, 31₂, . . . 31ₙ and other financial institutions 29₁, 29₂, . . . 29ₙ. Therefore, the clearinghouse 37 has instant access to all associates of a transaction. Before contacting a provider 27₁, 27₂, . . . 27ₙ, consumer 21 will have entered his or her personal and financial information into a file of a database associated with the clearinghouse 37. This information may include the consumer's name, address, social security number, sex, date of birth, credit card number, password, bank name, shipping address, billing address or the like. This file is associated with consumer 21 and in addition, also may be associated with other information, i.e., a particular provider or providers, a particular credit card number or the like.

The clearinghouse 37 databases may include a number of such files; each associated with a consumer 21 or other individuals. Each of these files also may be further associated with other information such as a different credit card number, a different provider or group of providers, or the like.

The clearinghouse 37 decrypts the form and renders decisions in real time regarding consumer authenticity and transaction veracity (step 113). Consumer authentication may be obtained using biometric data from the purchaser communicated by a smart POS communication device 23, or passwords between the consumer 21 and clearinghouse 37. A biometric device may be integrated into any part of a communication device 23. Some components of the biometric device may be at the providers 27₁, 27₂, . . . 27ₙ, participants 29₁, 29₂, . . . 29ₙ and banks 31₁, 31₂, . . . 31ₙ and connected to communication device 23 through the web 19.

Authentication may indicate only that the identity of consumer 21 has been verified. On the other hand, authentication may comprise a unique code, such as a number, password or other indicia uniquely associated with the consumer 21. This code may be transmitted encrypted or non-encrypted.

The clearinghouse 37 has a database for each associate. Associates include providers 27₁, 27₂, . . . 27ₙ, participants 29₁, 29₂, . . . 29ₙ, banks 31₁, 31₂, . . . 31ₙ, and consumer(s) 21. For a consumer 21, the clearinghouse 37 stores purchases, favored stores, number of purchases or the like, establishing a consumer centric financial processing model. The clearinghouse 37 databases may be stored in a RAM, ROM, EEPROM, magnetic tape, floppy disk, optical disk or any other computer memory device. The database may be associated with providers 27₁, 27₂, . . . 27ₙ, participants 29₁, 29₂, . . . 29ₙ, banks 31₁, 31₂, . . . 31ₙ, and consumer 21 and connected to communication device 23 through web 19.

Interchange fees for the use by provider 27₁, 27₂, . . . 27ₙ of clearinghouse 37 can be based on a flat fee per transaction, individual consumer preference history or demographics. Historical buying trends can be used for fee analysis to pass savings to the consumer by offering incentives from the banks 31₁, 3₂, . . . 31ₙ and providers 27₁, 27₂, . . . 27ₙ. For example, the more items purchased by consumer A from retailer B, the higher the discount bank C extends to its consumers (i.e. smaller interest rates).

The clearinghouse 37 determines what discounts and fees are applicable and what banks 31₁, 31₂, . . . 31ₙ to use from the information supplied by a consumer (step 115). Abbreviated clearing (step 117), authorization (step 119) and settlement information (step 121) are exchanged among the provider 27₁, 27₂, . . . 27ₙ, bank 31₁, 31₂, . . . 31ₙ and consumer 21 in real time (step 123). Transaction status information is returned to the point of sale or the consumer 21 in real time (step 125) as an e-Receipt (step 127).

The consumer 21's account is debited accordingly in real time to reflect the purchase. The consumer 21's account may represent a bank 31₁, 31₂, . . . 31ₙ savings account, checking account or bank credit line account. It may also represent a participant 29₁, 29₂ . . . 29ₙ credit organization. Contemporaneous with the consumer 21's account being debited, the provider's 27₁, 27₂, . . . 27ₙ account at his or her bank 31₁, 31₂, . . . 31ₙ is credited in real time from the consumer 21's bank 31₁, 31₂, . . . 31ₙ in a seamless transaction effected by the agents of clearinghouse 37.

Disputes, or what are more commonly known as chargebacks, and returned goods are dealt with in varying ways depending on the goods and services. However, they preferably follow a similar transaction flow.

For example, assume a consumer 21 received software for a 30-day free trial. The trial period ran and is over. The software provider 27₁, 27₂, . . . 27ₙ employs an intelligent agent that detects non-use on the consumer 21's communication device 23. The communicating device 23 is a personal computer for this example. The software provider's 27₁, 27₂, . . . 27ₙ agent notifies the consumer 21 that the trial period is over and informs the consumer 21 of several options. The agent requests that the consumer 21 either return the software without charge, extend the trial period for a modest fee or purchase the software. The consumer 21's response is to return the software. The provider's 27₁, 27₂, . . . 27ₙ agent removes the software from the consumer 21's communication device 23 and notifies the consumer 21 when complete. No charge activity occurs since this was a free trial with return.

Modifying the above example, the software provider's 27₁, 27₂, . . . 27ₙ agent notifies the consumer 21 that the trial period is over and informs him of the same options. The consumer 21's response is to extend the trial period. The software provider's 27₁, 27₂, . . . 27ₙ agent sends a new purchase transaction to the clearinghouse 37. If the transaction is a nominal amount under a predetermined maximum set by the consumer 21, authorization, clearing and settlement by the clearinghouse 37 occur automatically, in real time, using a default account number on where to debit the consumer 21's account obtained from the consumer's account/preference database.

Modifying the same example again, the consumer 21's response to the software provider's 27₁, 27₂, . . . 27ₙ is to return the trial software to the software provider 27₁, 27₂, . . . 27ₙ. The software provider's 27₁, 27₂, . . . 27ₙ agent removes the software from the communication device 23 and notifies the consumer 21 when complete. Contemporaneous with this action, the agent sends a chargeback transaction to the clearinghouse 37 to refund the original transaction amount.

The clearinghouse 37 verifies the identity and authenticity of the software provider's 27₁, 27₂, . . . 27ₙ agent. The agent is preferably a combination of executable software and its associated data, such as a Java applet, that can be downloaded to and executed on any platform with a Java virtual machine. Indeed, Java provides “code signing”, in which a chunk of code (such as an applet) has associated with it a digital certificate that is issued by a trusted party such as Verisign or the like. In this regard, the present invention capitalizes on code signing by checking the agent for necessary credentials (i.e., information sufficient to confirm its authenticity) when the agent arrives at the clearinghouse. Network-traveling and Java-based agents are also described in U.S. patent application Ser. Nos. 09/476,462 filed Dec. 30, 1999 and 60/170,718 filed Dec. 14, 1999, the disclosures of both of which are hereby incorporated by reference.

Although the invention is not limited to any particular method of authenticity, the following systems work synergistically with other aspects of the invention. In one system, the clearinghouse is the root of trust, and issues certificates to the various partners (banks, vendors, customers or the like). Thus, the clearinghouse trusts the partners, and vice versa. This trust relationship is typically backed up by legal agreements and service level agreements stating restrictions on who can do what to whom.

In another system, each entity that creates agents also has the ability to create certificates for those agents. Based on the trust hierarchy, when the user is receiving a new agent downloaded from the vendor, the user can check the digital certificate for that agent and determine whether it is signed by the vendor; subsequently, the vendor can point to the clearinghouse and inform the user that the clearinghouse can vouch for the vendor's authenticity. The user can verify this against the signature of the clearinghouse, and therefore trust the incoming agent.

Each software agent may also carry with it a description of what functions it performs, what services it will use on the mobile device (or on the clearing house when the agent is uploaded for execution), and other functions and information. All of these descriptions can also be signed by the trust hierarchy and backed up by the business agreements that went into the original relationship formed between the clearinghouse and the vendor.

Each time an agent traverses the network, it carries with it these signed credentials that allow the receiving party to track down and trust the hierarchy of entities that created and/or will vouch for the agent and its functions.

Returning to the prior example, the clearinghouse 37 agent contacts the software provider's 27₁, 27₂, . . . 27ₙ bank 31₁, 31₂, . . . 31ₙ and debits its account for the amount of the trial after proper authentication. The clearinghouse 37 agent then contacts the consumer's bank 31₁, 31₂, . . . 31ₙ and credits his or her account for the same amount. The bank acknowledges that the consumer 21's account has been credited and transmits an acknowledgement to the clearinghouse 37. The clearinghouse 37 agent completes the chargeback event by notifying the consumer 21 of the completed transaction via an e-Receipt.

For the purposes of illustration, the following example shall also be considered. A consumer 21 purchased a product from a department store 27₁, 27₂, . . . 27ₙ and decided to return the item, he or she selects the recent purchase from his or her database located at the clearinghouse 37 or from another communication device 23 such as a digital wallet and indicates that he or she wants to return the item to the physical location where it was purchased. The clearinghouse 37 agent notifies the department store 27₁, 27₂, . . . 27ₙ of the consumer 21's intent to return the goods and also notifies the consumer 21 of the location where to return the product. The consumer 21 returns the product to the specified location. While at the location, the department store 27₁, 27₂, . . . 27ₙ agent sends a chargeback transaction in real time to clearinghouse 37 to refund the original transaction amount. The clearinghouse 37 credits the specific account used for the initial transaction and notifies the consumer 21 of the event completion via an e-Receipt. The consumer 21 then leaves.

The integrated security of the invention prevents fraud prior to a purchase at a point of sale if the point of sale is a digital wallet. For this example, a purchase occurred at a store that did not have a smart point of sale terminal and customer 21 authentication and account validity could not be performed. Thirty minutes after the purchase occurred, the real consumer 21 is notified on a communication device 23 that a new e-Receipt appeared for goods that he or she did not purchase.

The consumer 21 selects the recent purchase on his or her digital wallet and indicates that it is a fraudulent purchase. The merchant's 27₁, 27₂, . . . 27ₙ agent notifies the merchant and the clearinghouse 37 of the fraudulent purchase. The merchant confirms the purchase was fraudulent, using a set of predetermined criteria to make this determination in real time. The agent sends a chargeback transaction to clearinghouse 37 to refund the original transaction amount. The clearinghouse 37 completes the chargeback event to the specific account used for the initial transaction event, and notifies the consumer of the completion of the event via an eReceipt. The merchant then proceeds to investigate and locate the goods by contacting the clearinghouse 37 for information about physical delivery/receipt.

One of the advantages of the present system is that its security aspects can be tailored to the product or service being purchased. For example, if the service relates to selling off a person's entire stock portfolio, then the system will likely require several checks and double checks of security, will probably encrypt every piece of data as it traverses the network, and will likely require a variety of user authentication techniques (fingerprint verification, 9digit PIN codes or the like). However, if the transaction is for a ten dollar CD, then economies of scale and user convenience issues may dictate less stringent fraud detection. For example, if each of the clearing house, vendor and bank must pay or incur expenses associated with transaction processing, then it may be economically infeasible to carry out a severe security check for a fairly small transaction. Moreover, users may be less accepting of obtrusive fraud protection when the transaction is relatively small. As a result, a lower-level of security might be used in some cases even though there will be more chances for fraud. The threat model is developed by the back-end processing partners, and they determine what they can risk in the balance of security /cost of operations.

Accordingly one level of security may only require the user to enter a simple 4-digit PIN code along with a password as the only means of authenticating the user. Although this information is often insecure or sometimes easily discernable, it may suffice for certain transactions.

The present invention provides a number of advantages. The present invention employs a platform-independent model that eliminates and/or provides open platform support available to any vendor of hardware or software, using industry, standard communication protocols and eliminates the need for the purchase and deployment of propriety hardware, such as transaction routing gateways.

It also allows the use of agents in a clearinghouse and financial transaction settlement such that the agent applies service-specific knowledge. For example, the agent preferably knows the vendor, it knows the business relationships that the vendor has with other banks and strategic partners, it can offer advice on which bank-issued account to use for the transaction in question, and it can dynamically access and analyze significant historical data stored on the clearinghouse's databases to make further decisions about how to manage the transaction.

The present invention also allows real-time transaction processing and fraud prevention (for higher-level security processes as described above) as well as the use of meta-data in transaction processing to augment the transaction in real-time. It further allows the incorporation of PKI-based security mechanisms as appropriate and the automatic and intelligent selection of the credit issuer based on meta-data. All of these activities may be carried out within a secure environment protected by digital signatures, certificates, encryption and the like.

The invention is also quite scalable, and can easily accommodate complex transactions. For example, if there is a complex business relationship which involves a number of different entities, such as one retailer offering benefits actually provided by another retailer, then more than one agent may be sent during the transaction.

In addition, the consumer is not burdened with actively participating in every step of the process; much of it is transparent to the user. Moreover, users are not required to change their view of commercial transactions. They still have control over choosing a credit card issuer (such as the bank or other entity that is the provider of credit) and the clearinghouse/settlement provider (such as Visa or another credit association such as MasterCard).

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A method of conducting a transaction over a network of nodes including a user node associated with a user, a merchant node associated with a merchant of goods or services, a bank node associated with account information pertaining to the user, and a clearinghouse node, the method comprising at the clearinghouse node:
receiving a request from the user node for the purchase of at least one of the goods or services of the merchant,
determining whether the user is authorized to purchase the good or service by exchanging information with the bank node such that the bank node updates the user account information in the event of authorization,
if the purchase is authorized, sending notification of the authorization to the user node and merchant node such that the good or service is not provided until such notification is received by the merchant.

2. The method of claim 1 further comprising recording purchases and reducing the cost of the good or service in the event the user has previously purchased goods or services from other merchants.
